(19) United States
(12) Patent Application Publication
(10) Pub. No.: US 2008/0148539 A1
(43) Pub. Date: Jun. 26, 2008

(54) Memorial with features from digital image source

(76) Inventors: Samuel Emerson Shepherd, Sauk Centre, MN (US); Chad David Althaus, Melrose, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/642,137

(22) Filed: Dec. 20, 2006

(51) Int. Cl. A61G 99/00; G06F 19/00

(52) U.S. Cl. 27/1; 700/98; 700/96

(57) ABSTRACT

One aspect of the invention is a method for making a memorial piece. The method includes capturing an initial digital image representative of memorial information. The digital image is edited to create an adjusted digital image, which is then converted to create a three-dimensional image. The three-dimensional image is used to generate a three-dimensional pattern, which in turn is used to generate a mold cavity. At least some memorial information is contained in the mold cavity. A rough casting is formed within the mold cavity such that the memorial information is imparted to the rough casting. The rough casting is then cleaned and prepared. The casting is then oxidized to form a memorial piece with memorial information thereon.

### BACKGROUND

The present invention relates to a memorial piece that includes realistic three-dimensional features that are derived from a digital image.

Memorial pieces can be prepared by a casting process, an engraving process or combinations of such processes. With a casting process, a pattern is typically formed that includes memorial information such as an epitaph and design. The epitaph and design are generally raised. As such, they extend away from the surface of the pattern. In one case, the letters are placed on the pattern by hand in order to provide the epitaph information. In order to add designs in some cases, a separate pattern is prepared by cutting away portions of a material to provide the desired design features. The pattern is then used to create a mold. Once the memorial piece is formed, engraving can take place in the piece.

There are limitations, however, in how clearly features, especially design features, will translate into the final memorial piece. Also, there are limitations in engraving in the memorial piece once it is formed. Where the memorial piece is a metallic material such as a bronze alloy, the engraving process is time-consuming and does not always produce a realistic-looking design. For these and other reasons, there is a need for the present invention.

### SUMMARY

The present invention is a memorial. In one embodiment, the memorial is a casted piece that includes memorial information thereon. In one case, the memorial is made with a method that includes capturing an initial digital image representative of memorial information. The digital image is edited to create an adjusted digital image, which is then converted to create a three-dimensional image. The three-dimensional image is used to generate a three-dimensional pattern, which in turn is used to generate a mold cavity. At least some memorial information is contained in the mold cavity. A rough casting is formed within the mold cavity such that the memorial information is imparted to the rough casting. The rough casting is then cleaned and prepared. The casting is then oxidized to form a memorial piece with memorial information thereon.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a front perspective view of a memorial in accordance with one embodiment of the present invention.

FIG. 2 illustrates flow diagram of a process for making a memorial in accordance with one embodiment of the present invention.

FIG. 3 illustrates a composite image used in making a memorial in accordance with one embodiment of the present invention.

FIG. 4 illustrates a converted three-dimensional representation of an image used in making a memorial in accordance with one embodiment of the present invention.

FIG. 5 illustrates an image after image editing in accordance with one embodiment of the present invention.

FIG. 6 illustrates a final composite image used to create a physical pattern used in making a memorial in accordance with one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,”. “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

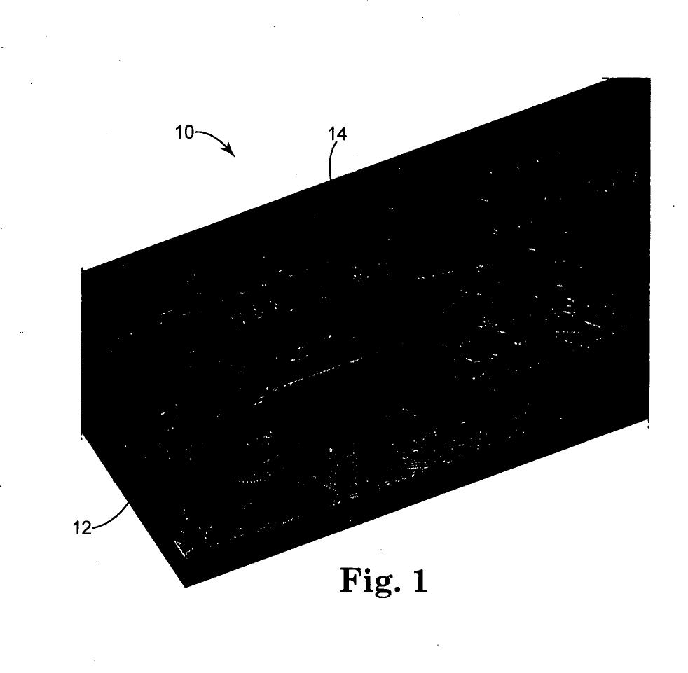

FIG. 1 illustrates memorial piece 10 in accordance with one embodiment of the present invention. In one embodiment, memorial piece 10 is provided having memorial information 14 thereon. In one example, memorial information 14 includes epitaph information, such as a brief statement commemorating or epitomizing a deceased person. The epitaph usually includes names and dates of birth and death. In some cases, the epitaph includes a brief statement about the deceased person or by the deceased person, handwritten personal information, a poem, and/or a signature. In the case of infants or small children, the epitaph may include a hand or palm imprint or a foot imprint. In still other examples, an epitaph can include nearly any of a variety of other decorative features.

Furthermore, memorial information 14 can include designs. In general, popular designs on memorials are artistic in nature. In some cases, such designs include angels, religious emblems, and floral borders.

In one embodiment, memorial piece 10 is a cast item such that it is formed by pouring a molten material into a specially formed mold. After the molten material hardens, the mold is opened and the memorial piece 10 is removed. The mold is configured with an inner cavity that contains the memorial information 14 such that the memorial information 14 is imparted on the surface of memorial piece 10 when it hardens. In one embodiment, the molten material poured into the mold is bronze, such that memorial piece 10 is a bronze piece. Memorial piece 10 can be configured to mark a burial ground. In some examples it can be configured for attachment to stone or other bases, and in other examples it can be an independent piece.

In one embodiment of the present invention, memorial information 14 includes an image 12, which is also provided in memorial piece 10. Image 12 can be any of a variety of scenes, people, animals and various other objects and combinations thereof. For example, image 12 could be a photograph of deceased person's spouse, family member(s), relative(s), or even of the deceased person themselves. Other images 12 could include photographs of a favorite pet or a favorite location, such as a cabin or outdoor scene.

In order to produce a memorial piece 10 with a very realistic looking image 12 as part of memorial information 14, one embodiment of the present invention utilizes a digital image source in order to generate image 12 that is included on memorial piece 10. In one case, the digital image source is a photograph that is created in, or converted to, a digital format. The digital image source is then edited and converted so that it can be used to create a three-dimensional pattern representative of the digital image. Then, a mixture of silica, sand, and resin is packed around the pattern to create a mold. This three-dimensional pattern forms the inner cavity of the mold. The mold is then separated and the pattern is removed. When the mold is then closed again, the inner cavity of the mold is defined by the pattern that was removed. Then, a molten metal, such as a bronze alloy, can be poured into the inner cavity of the mold and allowed to harden. Once the material is hardened, the mold is removed and memorial piece 10 with image 12 is left behind. The surface of memorial piece 10 is then polished and finished to provide a desirable finish.

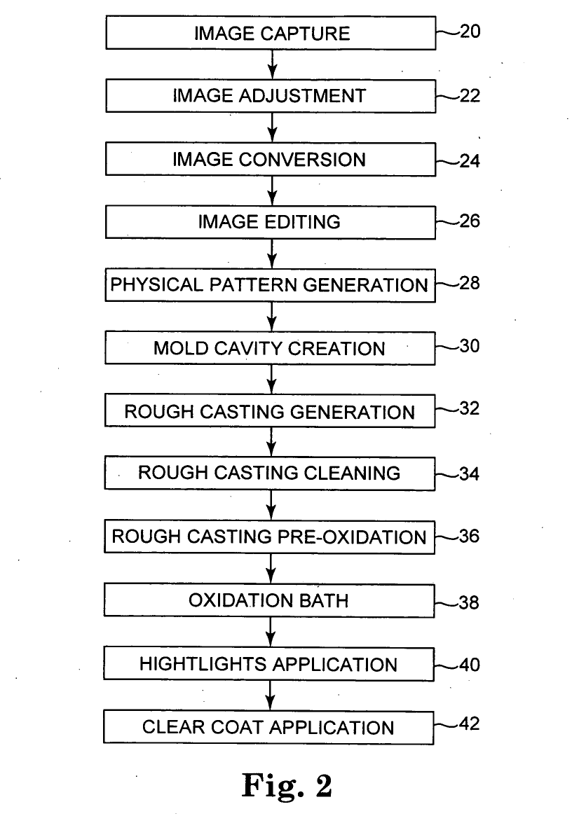

In order to ensure that image 12 accurately and realistically represents the digital image from which it is generated, however, certain process steps and refinements are used in association with embodiments of the present invention. FIG. 2 is a flow diagram illustrating certain such process steps to produce memorial piece 10 in accordance with embodiments of the present invention.

At step 20, an image capture is performed. In one case, a digital photograph is stored onto a computer as an initial digital image. In another case, a photograph on a physical media is electronically scanned to create an initial digital image, which is a digital representation of the photograph. The initial digital image, which represents the photograph, is then stored onto a computer. In one embodiment, a three-dimensional scan can be used in which a digital three-dimensional image is obtained of an object or of a person. These scanned images can be acquired by either a pixel scanner or laser scanner.

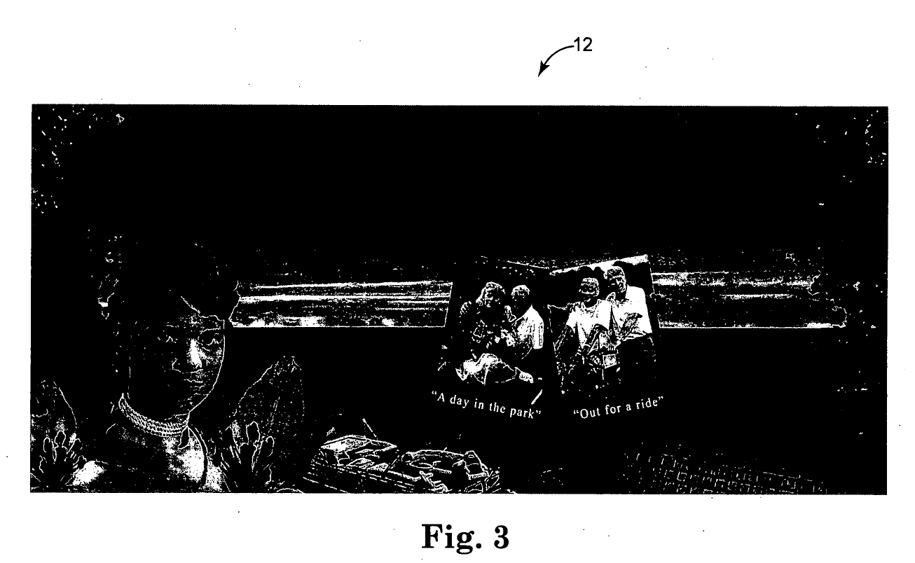

In one embodiment, a combination of digital images may be used to create the initial digital image. For example, a collage of images such as that illustrated in FIG. 3 can be used. In that example, various photographs are combined in a collage, which includes photographs from a lake, a favorite boat, child-hood photographs, and photographs with a spouse. In this case, the combined collage in the initial digital image.

In any case, once an initial digital image is stored on a computer, the initial digital image can then be manipulated at step 22 to create an adjusted digital image. Since the initial digital image will be used to create image 12 on memorial piece 10, it can be manipulated at this stage of the process in anticipation of some of the characteristics that will be desirable for image 12. For example, where the initial digital image is a photograph of a person, some dark and some light features of the image need to be lightened and darkened, respectively, in order to create the adjusted digital image. As such, a dimple on a person's face that appears dark would need to be slightly lightened before the final image is further processed. Also, where there is a bright light, such as direct sun, reflecting on a person's light hair, this would need to be slightly darkened.

If these dark features are not lightened or if these light features are not darkened, they will not translate well into the image 12 in memorial piece 10. This is especially the case when memorial piece 10 is a metal like bronze. As such, in certain circumstances where such adjustments are not made to the initial digital image, dark and light features may be lost or rendered too subtle to be noticed. In this way, the image 12 will not look realistic or authentic when too many of these dark or light features are lost because they were not adjusted. When the features are adjusted for lightness and darkness, however, image 12 is a realistic and faithful representation of the initial digital image from which it is created.

In one embodiment, an initial digital image such as a photograph is imported into image manipulation software such as Photoshop® or some such similar program. Once the initial digital image is imported into the image manipulation software, adjustments to the darkness, lightness and contrast are accomplished with the adjustment tools available in the software. These can be optimized to ensure that all the features of the image will ultimately translate into bronze images. The image manipulation software creates the adjusted digital image.

In the examples where the initial digital image is a collage of images, it may be desirable to adjust each of the individual images separately to create the adjusted digital image via the combination of the individually adjusted images.

At step 24, the adjusted digital image is converted into a three-dimensional image. When the initial digital image is a representation of a photograph of a person, for example, the two-dimensional image is converted into a three-dimensional one, in order to produce a three-dimensional digital surface from images. In this way, the desired height for features can be applied to the image. For example, for the photograph of a person, a feature like a nose should have height such that it is raised relative to the surface of memorial piece 10, while a feature like a dimple in a cheek should have depth such that it is recessed relative to the surface of memorial piece 10.

In one embodiment, an adjusted digital image, such as of a photograph, is imported into image conversion software such as ArtCAM® or some such similar program to generate the three-dimensional image. In such case, the two-dimensional adjusted digital image is analyzed so that relative heights can be assigned for the various features of the image. In one case, a gray scale conversion is used in the process, that is, variations in height are represented by variations in the gray scale.

In one embodiment, in order for the conversion to translate well into a final memorial piece 10, such as one made of bronze, a depth of between about 1/16 inch and about ⅛ inch is used for the recesses and a similar height is used for raised areas. In other embodiments, a relief of 45 thousandths on an inch to 60 thousandths of an inch is used for depth and raised areas.

In one embodiment, a three-dimensional scan is used such that a digital three-dimensional image is obtained directly. As such, no conversion of the image is needed, as the three-dimensional image is initially captured.

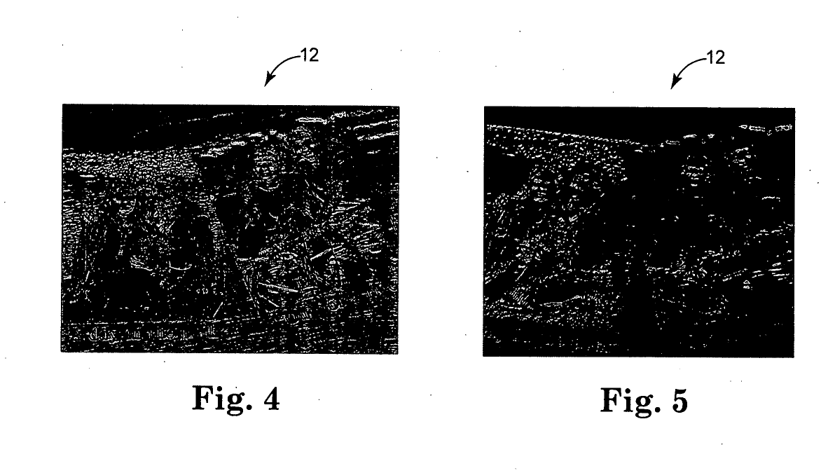

FIG. 4 illustrates one example of a three-dimensional image in accordance with one embodiment of the present invention. A portion of the initial digital image illustrated in FIG. 3 is illustrated in FIG. 4 after its conversion to a three-dimensional image. Two photographs from the center of the collage of FIG. 3 are further illustrated in FIG. 4 after the conversion of step 24. As is evident, the three-dimensional image has some rough areas that will need further processing in order to provide a good representation of the images.

Accordingly, once a three-dimensional image is generated or otherwise obtained, the image is edited at step 26 to produce an edited image. In this step, the digital surface of the three-dimensional image is sculpted or cleaned in order to produce desired results in the machining step to be performed subsequently. In some cases “virtual material” must be added or removed in order to produce a desired surface for the machining step. For example, the sculpting and cleaning step can be used to remove pits and to add material where needed to created the edited image.

FIG. 5 illustrates an example of an edited image in accordance with one embodiment of the present invention. Here, the three-dimensional image from FIG. 4 has been edited to improve the overall representation. Virtual material has been added and other material has been removed to give a more smooth appearance. For example, the male subject in the right-most figure has been edited. Focusing on his forearm, which extends to the bicycle handle, it is evident that material has been added in certain places and removed in others to improve the overall appearance. If the arm from FIG. 4 is compared to that in FIG. 5, it is evident that the added material removed the pits and raised areas, giving the arm a more smooth appearance.

Furthermore, additional memorial information 14 can be added to the edited image with this step of producing the edited image. For example, lettering can be added to the edited image, as can designs or other features. In this way, the memorial information 14, including lettering and designs, for the memorial piece 10 can be added at this stage to the three-dimensional image and creating the edited image. When image-conversion software such as ArtCAM® is used, such lettering and designs can be added within the context of the program functions. As such, the edited image will include the memorial information 14 that will eventually be included on memorial piece 10.

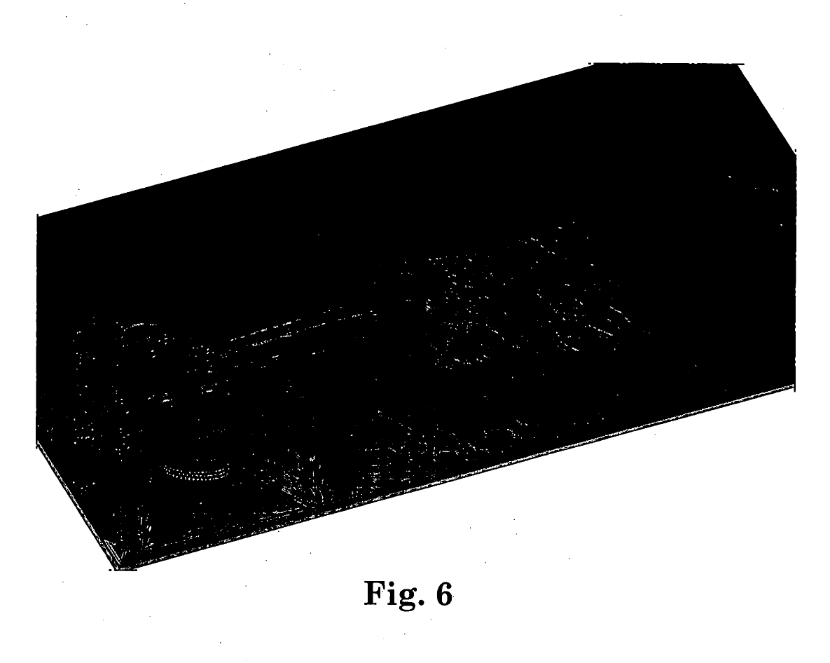

FIG. 6 illustrates such an exemplary edited image. In the example edited image of FIG. 6, the initial image from FIG. 2 is illustrated after it has gone through the adjustment step 22, the conversion step 24, and the image editing step 26. Lettering, such as the decedent's name and dates of birth and death, can also be added at this step.

Once the three-dimensional image is finally edited, the edited image is ready to be used to generate an actual physical three-dimensional pattern at step 28. In this step, the edited image is sent to a computer numeric control or CNC machine. The CNC machine drives a router, or plurality of routers, using the digital data of the edited three-dimensional image in order to sculpt an actual physical three-dimensional pattern that approximates the edited three-dimensional image. The physical three-dimensional pattern then includes the memorial information 14 that will eventually be included on memorial piece 10. The physical three-dimensional pattern can represent a complete memorial/sign or a just a part of a memorial that is then set onto another pre-made pattern to form the complete memorial.

In one embodiment, the CNC machine is driven by G-code software, which takes commands from the digital data of the edited image to drive routers. This step begins with a raw piece of material that is sculpted with routers in accordance with the CNC machine to result in the physical three-dimensional pattern that approximates the edited image. The raw piece to be sculpted can be comprised of any of a variety materials, for example, wood or plastic. In some cases, inert materials are used because they tend not to expand and contract with changes in humidity, and thus provide a more consistent output.

In one embodiment, creating the physical three-dimensional pattern in step 28 further includes selecting and creating tool paths for the machining of pattern. For example, some images and/or letters can require particular bits and/or tools in order to machine correctly, such that different bits and/or tools should be selected for different images or letters. Some cuts are more coarse requiring a larger bit and/or tool, while others are much more fine requiring a smaller bit and/or tool. As such, the bit and/or tool can be selected within the G-code controlling the CNC machine. Furthermore, a machining strategy can be planned within the setup of the CNC machine for this step. For example, the machine can be instructed as to what part of the image should use which bit and/or tool. Also, instructions can be given to determine what steps should be taken in what order. Also, a particular path can be programmed.

Once the physical three-dimensional pattern is formed, an inner cavity of a mold is created at step 30. Here, the physical three-dimensional pattern is placed into a mixture of fine silica, sand, and resin, which is then packed around the physical three-dimensional pattern. The sand mixture is then allowed to harden; thereby forming a mold with the three-dimensional pattern defining and forming the inner cavity that will then be cast. As such, the inner cavity of the mold includes the memorial information 14 that will eventually be included or imparted on memorial piece 10. The sand mold is then separated so that the physical three-dimensional pattern can be removed, and then the sand mold is reassembled so that the inner cavity of the mold can be used for casting.

At step 32, a rough casting is created by pouring a molten material, such as a bronze alloy, into the inner cavity of the mold and allowing the material to harden. Typically, runners are incorporated into the mold to help facilitate pouring the molten material in to the mold. Once the material hardens, thereby forming the rough casting, the rough casting will include the memorial information 14 that is contained on the inner cavity of the mold.

In one embodiment, the rough casting is a bronze metal material. In general, bronze is a material which includes at least about 50% by weight copper. In one example of bronze for use as a memorial piece 10, the copper component is provided in an amount of about 87% by weight or higher. It should be appreciated, however, that various types of materials can be processed by the invention. Bronze does provide a high degree of longevity in many applications.

Next, at step 34, the rough casting is cleaned to produce a cleaned casting. In one embodiment the cleaning process involves using a variety of abrasive tools and cleaning techniques. For example, the rough casting will include small amounts of sand from the mold and these must be cleaned away. Also, small raised areas on the rough casting will need to be cleaned off with an abrasive, such as an abrasive sand paper. The memorial information 14 should not be cleaned away, so this cleaning process is a delicate process that is done by hand so that only the small raised areas and rough spots are removed by hand rubbing the abrasive material over these areas so as not the distort the memorial information 14.

In one embodiment, the rough casting has pores and this cleaning process tends to close the pores of the rough casting. As such, at step 36 the cleaned casting is further cleaned and prepared to accept an oxidization chemical (which will be added in a later step), thereby forming a prepared casting. In order to prepare the surface of the cleaned casting for oxidization, an abrasive blast or chemical cleaning is applied to the surface. This will help open the surface pores of the bronze or metal of the prepared casting. For example, a silica blast or sand blast can be used to remove only microscopic particles in order to open pores, while at the same time not altering or degrading the memorial information on the surface.

At step 38, the prepared casting is placed in an oxidization bath to produce an oxidized piece. In one embodiment, the prepared casting is soaked in the oxidization bath until the surfaces have fully oxidized. It is then removed and put into a neutralizing bath. In one case, the neutralizing bath is water. In one embodiment, a special combination of oxidization coloring is used that mixes two different colors, brown patina and black patina. This combination of brown and black patina gives a rich look to the final memorial piece 10.

At step 40, highlights are applied to the oxidized piece by removing some of the oxidization. For example, removing the oxidization from the high spots of the surface allows for the illusion of more depth in the surface and accentuates the photographic qualities of the finished piece. In one case, a wire brush or 3M scotch bright pads are used to remove heightened features. This removal will give the piece a clean photograph-like look.

Finally, at step 42 the piece is coated with a clear coat to produce the final memorial piece 10. The clear coat is applied to the memorial 10 to protect the bronze from further oxidizing. In one embodiment, a special clear coat finish different from the standard gloss memorial finish is utilize to help the photographic features surface stand out. The standard gloss finish tends to create a significant amount of light refraction in the final piece, whereas the clear coat finish tends not to cause as much refraction, thereby giving the piece a sharper image.

Other processes are possible to produce memorial piece 10 in accordance with the present invention. For example, steps 20-24 can be used to generate a three-dimensional image, including grayscale representations of the source image. Then, rather than creating the physical three-dimensional pattern with the process steps 26-28 above, an alternative liquid polymer process step can be substituted instead in accordance with an embodiment of the present invention.

In this alternative liquid polymer process embodiment, the three-dimensional image produced at step 24 is used to print the grayscale image onto an image-setting film. The film is then used to “expose” the bottom side of a polymer pattern. This will then build the image or background relief on the plate.

Next, lettering layout can be added and the image is printed onto the image-setting film. The film is then used to “expose” the topside of the polymer pattern in order to build the lettering on the plate. The bottom film is the placed on a light exposure unit, then a separator and liquid polymer material is poured over the pattern. Then, the separator and top film is placed on the exposure unit. The top film and bottom film must be carefully aligned on the exposure unit.

The bottom side (relief) is exposed for a specified time. Then, the topside is exposed to build the lettering on the background. Finally, the exposed polymer is removed from the exposure unit. Any excess (unexposed to light polymer material) material is removed from the polymer pattern, and the polymer pattern is placed in a washout machine to clean minute traces of unexposed polymer from plate and then post expose and dry.

The result is a three-dimensional pattern, such as the produced at step 28 above, that can then be used to create the cast for molding. As such, this three-dimensional pattern can be used in conjunction with steps 30-42 discussed above to produce a final memorial piece 10 in accordance with the present invention.

In another alternative embodiment in accordance with the present invention, steps 20-24 can again be used to generate a three-dimensional image, including grayscale representations of the source image. Then, rather than creating the physical three-dimensional pattern with the process steps 26-28 above, an alternative three-dimensional printing process can be substituted instead in accordance with an embodiment of the present invention.

In this alternative three dimensional printing process embodiment, the three-dimensional image produced at step 24 is used to print a three-dimensional pattern by building the pattern in layers. From the three-dimensional image, a slicing algorithm draws detailed information for every layer. Each layer begins with a thin distribution of powder spread over the surface of a powder bed. Using a technology similar to ink-jet printing, a binder material selectively joins particles where the object or pattern is to be formed. A piston that supports the powder bed and the part-in-progress lowers so that the next powder layer can be spread and selectively joined. This layer-by-layer process repeats until the pattern is completed. Following a heat treatment, unbound powder is removed, leaving the physical three-dimensional pattern.

This physical three-dimensional pattern, such as the produced at step 28 above, that can then be used to create the cast for molding. As such, this printed three-dimensional pattern can be used in conjunction with steps 30-42 discussed above to produce a final memorial piece 10 in accordance with the present invention.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for making a memorial piece, the method comprising:
obtaining a digital three-dimensional image;
generating a physical three-dimensional pattern from the three-dimensional image, wherein the physical three-dimensional pattern includes a representation of the image thereon;
generating a mold cavity using the three-dimensional pattern such that at least some of the image is contained in the mold cavity; and
forming a memorial piece within the mold cavity such that the image is imparted to the memorial piece.

2. The method of claim 1, wherein the physical three-dimensional pattern further comprising memorial information thereon, such that the memorial information is contained in the mold cavity and is imparted to the memorial piece.

3. The method of claim 1 further comprising editing an initial digital image in order to create an adjusted digital image, wherein editing includes darkening or lightening features of the image.

4. The method of claim 3 further comprising converting the adjusted digital image to create the digital three-dimensional image and wherein the initial digital image is a photograph including a person.

5. The method of claim 1, wherein obtaining the digital three-dimensional image further comprises obtaining a gray scale conversion such that variations in height in the image are represented by variations in the gray scale.

6. The method of claim 1, wherein forming the memorial piece within the mold cavity further comprises forming a rough casting within the mold cavity such that the image is imparted to the rough casting, cleaning and preparing the rough casting, and oxidizing the casting to form the memorial piece with the image thereon.

7. The method of claim 6, wherein oxidizing the casting further comprises placing the casting in a combination of oxidization coloring that mixes brown patina and black patina.

8. The method of claim 1, wherein forming a memorial piece within the mold cavity further comprises pouring molten bronze into the mold cavity.

9. The method of claim 1, wherein generating the physical three-dimensional pattern from the three-dimensional image further comprises sending the three-dimensional image to a computer numeric control (CNC) machine such that the CNC machine controls cutting tools to generate the physical three-dimensional pattern.

10. The method of claim 1, wherein generating the physical three-dimensional pattern from the three-dimensional image further comprises using a liquid polymer process wherein the three-dimensional image is used on an image-setting film to generate the physical three-dimensional pattern.

11. The method of claim 1, wherein generating the physical three-dimensional pattern from the three-dimensional image further comprises using a three-dimensional printing process wherein the three-dimensional image is used to print a three-dimensional pattern by building the pattern in layers.

12. A method for making a memorial piece, the method comprising:
capturing an initial digital image representative of memorial information;
editing the digital image to create an adjusted digital image;
converting the adjusted digital image to create a three-dimensional image;
generating a three-dimensional pattern from the three-dimensional image;
generating a mold cavity from the three-dimensional pattern such that at least some memorial information is contained in the mold cavity;
forming a rough casting within the mold cavity such that the memorial information is imparted to the rough casting;
cleaning and preparing the rough casting; and
oxidizing the casting to form a memorial piece with memorial information thereon.

13. The method of claim 12, wherein obtaining the digital three-dimensional image further comprises obtaining a gray scale conversion such that variations in height in the image are represented by variations in the gray scale.

14. The method of claim 12, wherein oxidizing the casting further comprises placing the casting in a combination of oxidization coloring that mixes brown patina and black patina.

13. The method of claim 12, wherein generating the physical three-dimensional pattern from the three-dimensional image further comprises sending the three-dimensional image to a computer numeric control (CNC) machine to generate the physical three-dimensional pattern.

15. The method of claim 12, wherein generating the physical three-dimensional pattern from the three-dimensional image further comprises using a liquid polymer process to generate the physical three-dimensional pattern.

16. The method of claim 12, wherein generating the physical three-dimensional pattern from the three-dimensional image further comprises using a three-dimensional printing process to generate the physical three-dimensional pattern.

17. A memorial piece comprising:
memorial information; and
a representation of an image;
wherein memorial piece is formed within a mold cavity that includes features of the image;
wherein the mold cavity is formed using a three-dimensional pattern that includes features of the image; and
wherein the physical three-dimensional pattern is derived from a digital three-dimensional image.

18. The memorial piece of claim 17, wherein the digital three-dimensional image is derived from an initial digital that is a photograph that is adjusted.

19. The memorial piece of claim 17, wherein forming the memorial piece within the mold cavity further includes forming a rough casting within the mold cavity such that the image is imparted to the rough casting, cleaning and preparing the rough casting, and oxidizing the casting to form the memorial piece with the image thereon.

20. The memorial piece of claim 17, wherein the memorial piece is formed from molten bronze that is poured into the mold cavity.

21. The memorial piece of claim 17, wherein deriving the physical three-dimensional pattern from the three-dimensional image includes sending the three-dimensional image to a computer numeric control (CNC) machine such that the CNC machine controls cutting tools to generate the physical three-dimensional pattern.

22. The memorial piece of claim 17, wherein deriving the physical three-dimensional pattern from the three-dimensional image includes using a liquid polymer process wherein the three-dimensional image is used on an image-setting film to generate the physical three-dimensional pattern.

23. The memorial piece of claim 17, wherein deriving the physical three-dimensional pattern from the three-dimensional image includes using a three-dimensional printing process wherein the three-dimensional image is used to print a three-dimensional pattern by building the pattern in layers.
